(19) United States
(12) Patent Application Publication
(10) Pub. No.: US 2021/0151722 A1
(43) Pub. Date: May 20, 2021

(54) BATTERY PACK

(71) Applicant: TOYOTA JIDOSHA KABUSHIKI KAISHA, Toyota-shi (JP)

(72) Inventor: Kohji UMEMURA, Okazaki-shi (JP)

(21) Appl. No.: 16/929,198

(22) Filed: Jul. 15, 2020

(30) Foreign Application Priority Data
Nov. 19, 2019 (JP) 2019-208837

(51) Int. Cl. H01M 2/10; H01M 10/04; H01M 10/0585; H01M 10/42; H01M 2/14; H01M 2/30; H01M 2/26

(52) U.S. Cl. CPC H01M 2/1077; H01M 10/0413; H01M 10/0585; H01M 10/0525; H01M 2/14; H01M 2/30; H01M 2/26; H01M 10/4207

(57) ABSTRACT

A battery pack disclosed herein includes: a plurality of single cells each having an electrode body and a battery case housing the electrode body, and arrayed in a predetermined direction; and one or more spacers each disposed between two of the single cells that are adjacent to each other in the predetermined direction. The spacer has, on at least one of surfaces facing the single cells, a convex portion that protrudes toward the single cell. The convex portion is in contact with the battery case of the single cell. A contact portion of the battery case that is a portion in contact with the convex portion protrudes into the battery case so as to be able to stop the electrode body from moving in a direction toward the contact portion.

### CROSS-REFERENCE TO RELATED APPLICATION

This application claims priority to Japanese Patent Application No. 2019-208837 filed on Nov. 19, 2019, incorporated herein by reference in its entirety.

### BACKGROUND

### 1. Technical Field

The disclosure relates to a battery pack.

### 2. Description of Related Art

To achieve higher outputs, secondary batteries that are used as onboard power sources, such as lithium-ion secondary batteries and nickel-metal hydride secondary batteries, are commonly used in the form of a battery pack in which a plurality of single cells is connected in series.

Typically, a battery pack has a configuration in which a plurality of single cells is arrayed (stacked) in a predetermined direction, with a spacer interposed between the single cells, and a binding load is applied to the battery pack (e.g., see Japanese Patent Application Publication No. 2015-041484). In JP 2015-041484 A, spacers are each disposed at a central part of a flat surface of a single cell, and the central part of the flat surface of the single cell is dented by a load into a shape matching the outline of the spacer. According to JP 2015-041484 A, this configuration can reduce the likelihood that a welded area between a lid and a main body of a battery case may undergo fatigue deterioration when the internal pressure of the battery case rises.

### SUMMARY

However, a thorough review by the inventors has found that when a vehicle equipped with the battery pack of the related art represented by the above one is subjected to external impact, for example, as the vehicle runs over a bump in the road, the electrode bodies inside the single cells move, which may result in damage, such as internal short-circuit or internal disconnection of terminals. In this respect, there is room for improvement.

An object of the disclosure is therefore to provide a battery pack that is less prone to damage due to external impact.

A battery pack disclosed herein includes: a plurality of single cells each having an electrode body and a battery case housing the electrode body, and arrayed in a predetermined direction; and one or more spacers each disposed between two of the single cells that are adjacent to each other in the predetermined direction. The spacer has, on at least one of surfaces facing the single cells, a convex portion that protrudes toward the single cell. The convex portion is in contact with the battery case of the single cell. A contact portion of the battery case that is a portion in contact with the convex portion protrudes into the battery case so as to be able to stop the electrode body from moving in a direction toward the contact portion.

Thus configured, the battery pack provided by the disclosure is less prone to damage due to external impact.

In one aspect of the battery pack disclosed herein, the contact portion is located so as to face an end portion of the electrode body.

The battery pack thus configured is even less prone to damage due to external impact.

In another aspect of the battery pack disclosed herein, an electrode terminal is mounted on the battery case, and the contact portion is located so as to face an end portion of the electrode body on the side of the electrode terminal.

The battery pack thus configured is much less prone to damage due to external impact.

In yet another aspect of the battery pack disclosed herein, the spacer further has, on at least one of the surfaces facing the single cells, a second convex portion that protrudes toward the single cell; a contact portion of the battery case that is a portion in contact with the second convex portion protrudes into the battery case so as to be able to stop the electrode body from moving in a direction toward the contact portion in contact with the second convex portion; and the contact portion in contact with the second convex portion is located so as to face an end portion of the electrode body on the opposite side from the electrode terminal.

The battery pack thus configured is far less prone to damage due to external impact.

In yet another aspect of the battery pack disclosed herein, each of the spacers has a convex portion on each surface, and contact portions of the battery case of the single cell sandwiched between the spacers that are portions in contact with the convex portions protrude into the battery case and keep the electrode body in place by holding the electrode body from both sides.

The battery pack thus configured is even less prone to damage due to external impact.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a perspective view schematically showing one example of a battery pack according to an embodiment;

FIG. 2 is a plan view schematically showing a single cell shown in FIG. 1;

FIG. 3 is a vertical sectional view schematically showing the single cell shown in FIG. 1;

FIG. 4 is an exploded view schematically showing an electrode body shown in FIG. 3;

FIG. 5 is a partial sectional view schematically showing a rear part of the battery pack according to the embodiment;

FIG. 6 is a plan view schematically showing a preferred form of the single cell;

FIG. 7 is a schematic view showing part of the configuration of a test piece for Test Example 1;

FIG. 8 is a schematic view showing part of the configuration of a test piece for Test Example 3; and

FIG. 9 is a graph showing an evaluation result of a test on the resistance of a weld to fatigue deterioration in each test example.

### DETAILED DESCRIPTION OF EMBODIMENTS

A preferred embodiment of a battery pack disclosed herein will be described below with reference to the drawings as necessary. The embodiment described here is, of course, not intended to particularly limit the disclosure. The battery pack disclosed herein can be implemented based on the contents disclosed in this specification and the technical common knowledge in this field.

In the drawings referred to below, those members and parts that have the same workings may be denoted by the same reference signs to omit or simplify an overlapping description. Reference signs U, D, F, Rr, L, and R in the drawings mean up, down, front, rear, left, and right, respectively. Reference signs X, Y, and Z in the drawings mean an array direction of single cells, a width direction of a long-side wall of the single cell, and a vertical direction of the long-side wall of the single cell, respectively. However, these directions are merely for the convenience of description and do not in any way limit the form of installation of the battery pack. The dimensional relationships (lengths, widths, thicknesses, etc.) in the drawings do not reflect the actual dimensional relationships.

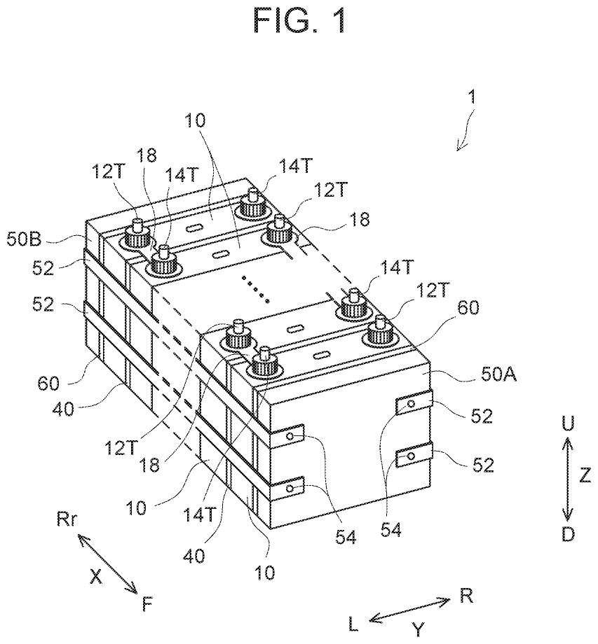

FIG. 1 is a perspective view schematically showing a battery pack 1 that is one example of embodiments according to the disclosure. The battery pack 1 includes a plurality of single cells 10 and a plurality of spacers 40. The battery pack 1 further includes a binding mechanism. Specifically, the battery pack 1 includes, for example, a pair of end plates 50A, 50B, a plurality of binding bands 52, and a plurality of screws 54 as shown in FIG. 1. The pair of end plates 50A, 50B is disposed at both ends of the battery pack 1 in a predetermined array direction X (a front-rear direction in FIG. 1). Each binding band 52 is mounted on the pair of end plates 50A, 50B like a bridge therebetween. The single cells 10 are arrayed in the array direction X. The spacers 40 are each disposed between two of the single cells 10 that are adjacent to each other in the array direction X. Two end spacers 60 are disposed respectively between the single cell 10 and the end plate 50A and the single cell 10 and the end plate 50B. The number of the single cells 10 is not particularly limited as long as the number is not smaller than two. When the battery pack 1 has two single cells 10, the battery pack 1 has one spacer 40.

The end plates 50A, 50B sandwich the single cells 10, the spacers 40, and the two end spacers 60 in the array direction X. The binding bands 52 are fixed to the end plates 50A, 50B with the screws 54. Each binding band 52 is mounted so as to apply a specified binding pressure in the array direction X. The binding bands 52 are mounted, for example, such that a contact pressure on an area of the single cell 10 that is pressed by the spacer 40 is roughly 90 to 600 kgf/cm², for example, about 200 to 500 kgf/cm². Thus, a load is applied to the single cells 10, the spacers 40, and the two end spacers 60 from the array direction X, so that the battery pack 1 is integrally held. In the shown example, the binding mechanism is composed of the end plates 50A, 50B, the binding bands 52, and the screws 54, but the binding mechanism is not limited to this example.

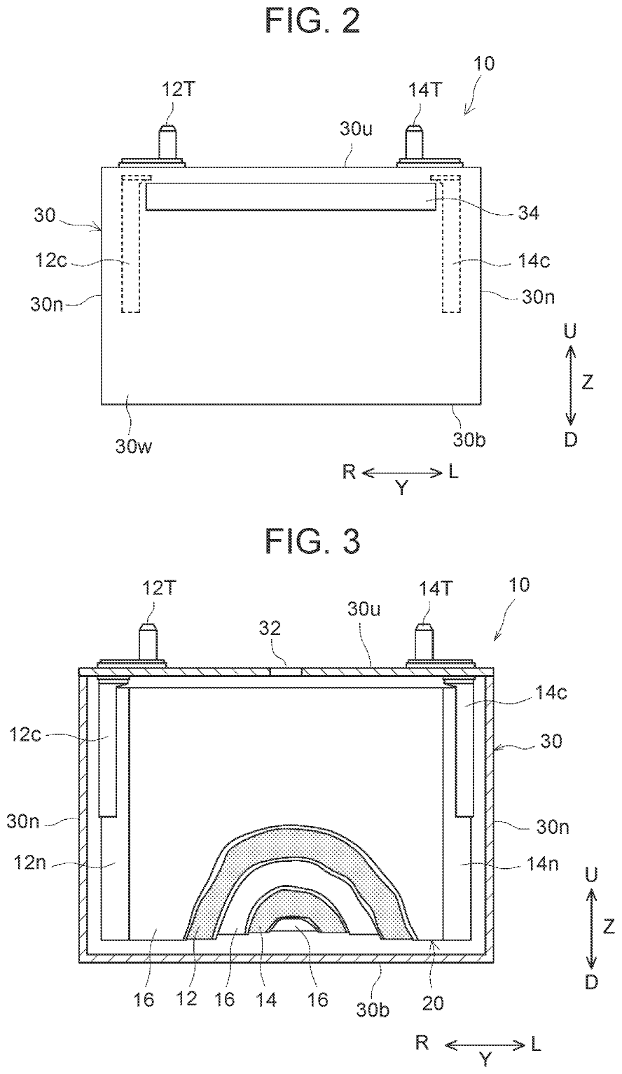

FIG. 2 is a plan view schematically showing the single cell 10. FIG. 3 is a vertical sectional view schematically showing the single cell 10. The single cell 10 is typically a secondary battery capable of charging and discharging repeatedly, for example, a lithium-ion secondary battery, a nickel-metal hydride battery, or an electric double-layer capacitor. The single cell 10 includes an electrode body 20, an electrolyte (not shown), and a battery case 30.

The battery case 30 is a case housing the electrode body 20 and the electrolyte. The battery case 30 is made of, for example, metal, such as aluminum or steel. The battery case 30 in the shown example has a rectangular outer shape with a bottom (rectangular parallelepiped shape). The battery case 30 is composed of a lid and a case main body. The lid and the case main body are joined together by welding, such as laser welding.

The battery case 30 has an upper wall 30u, a bottom wall 30b facing the upper wall 30u, and a pair of short-side walls 30n and a pair of long-side walls 30w as side walls continuing from the bottom all 30b. The lid of the battery case 30 is formed by the upper wall 30u, and the case main body thereof is formed by the bottom wall 30b, the pair of short-side walls 30n, and the pair of long-side walls 30w. The case main body is formed, for example, by performing deep drawing on one metal sheet. The pair of short-side walls 30n and the pair of long-side walls 30w each have a flat part. The thicknesses (plate thicknesses) of the bottom wall 30b, the pair of short-side walls 30n, and the pair of long-side walls 30w are roughly 1 mm or less, typically 0.5 mm or less, for example, 0.3 to 0.4 mm. The pair of long-side walls 30w of each battery case 30 faces the spacers 40, except at end portions of the battery pack 1. At each end portion of the battery pack 1, the pair of long-side walls 30w of the battery case 30 faces the spacer 40 and the end spacer 60.

The upper wall 30u of the battery case 30 is provided with a thin safety valve 32 that is set to release the internal pressure of the battery case 30 when the internal pressure has risen to or beyond a predetermined level. The upper wall 30u of the battery case 30 is further provided with a filling port (not shown) through which the electrolyte is poured. A positive-electrode terminal 12T and a negative-electrode terminal 14T for external connection are mounted on the upper wall 30u of the battery case 30. The positive-electrode terminal 12T of one single cell 10 and the negative-electrode terminal 14T of an adjacent single cell 10 are electrically connected to each other through a bus bar 18. Thus, the single cells 10 are electrically connected in series. However, the shape, size, number, arrangement, connection method, etc. of the single cells 10 forming the battery pack 1 are not limited to those in the aspect disclosed herein but can be changed as necessary. For example, some or all of the single cells 10 of the battery pack 1 may be electrically connected in parallel.

The configuration of the electrode body 20 and the electrolyte housed inside the battery case 30 may be the same as a conventional one and is not particularly limited. The electrolyte is, for example, a nonaqueous electrolyte containing a nonaqueous solvent and a supporting electrolyte. The nonaqueous solvent is, for example, carbonate, such as ethylene carbonate (EC), dimethyl carbonate (DMC), or ethyl methyl carbonate (EMC). The supporting electrolyte is, for example, lithium salt, such as LiPF₆ or LiBF₄.

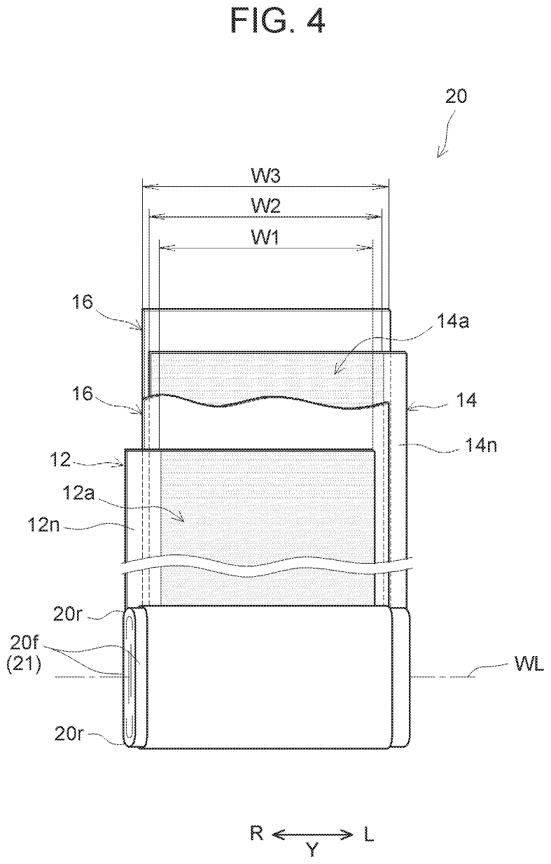

FIG. 4 is an exploded view schematically showing the electrode body 20. In the shown example, the electrode body 20 is a rolled electrode body. The electrode body 20 is formed by laminating a band-shaped positive electrode 12 and a band-shaped negative electrode 14 so as to be insulated from each other by band-shaped separators 16, and rolling this laminate around a rolling axis WL.

The positive electrode 12 includes a positive-electrode current collector and a positive-electrode active material layer 12a anchored to a surface of the positive-electrode current collector. The positive-electrode active material layer 12a contains a positive-electrode active material that can reversibly occlude and release charge carriers, for example, lithium transition metal composite oxide. The negative electrode 14 includes a negative-electrode current collector and a negative-electrode active material layer 14a anchored to a surface of the negative-electrode current collector. The negative-electrode active material layer 14a contains a negative-electrode active material that can reversibly occlude and release charge carriers, for example, a carbon material. The separators 16 are porous members through which charge carriers can pass and which insulate the positive-electrode active material layer 12a and the negative-electrode active material layer 14a from each other.

In a width direction Y of the electrode body 20, a width W3 of the separator 16 is larger than a width W1 of the positive-electrode active material layer 12a and a width W2 of the negative-electrode active material layer 14a. The width W2 of the negative-electrode active material layer 14a is larger than the width W1 of the positive-electrode active material layer 12a. Thus, W1, W2, and W3 meet a condition W1<W2<W3. In the range of the width W1 of the positive-electrode active material layer 12a, the positive-electrode active material layer 12a and the negative-electrode active material layer 14a face each other while being insulated from each other.

An exposed positive-electrode current collector portion 12n is provided at a right end of the electrode body 20 in the width direction Y. A positive-electrode current collector plate 12c for a current collecting foil is attached to the exposed positive-electrode current collector portion 12n. The positive electrode 12 of the electrode body 20 is electrically connected to the positive-electrode terminal 12T through the positive-electrode current collector plate 12c. An exposed negative-electrode current collector portion 14n is provided at a left end of the electrode body 20 in the width direction Y. A negative-electrode current collector plate 14c for a current collecting foil is attached to the exposed negative-electrode current collector portion 14n. The negative electrode 14 of the electrode body 20 is electrically connected to the negative-electrode terminal 14T through the negative-electrode current collector plate 14c.

The electrode body 20 has a flattened appearance. As seen in a cross-section orthogonal to the rolling axis WL, the electrode body 20 has a pair of flat roll portions 20f and a pair of round roll portions 20r interposed between the pair of flat roll portions 20f A pair of end portions of the electrode body 20 in the width direction Y is open, and an inside and outside of the electrode body 20 communicate with each other at the end portions in the width direction Y.

In the single cell 10, one of the pair of round roll portions 20r of the electrode body 20 is disposed on the side of the bottom wall 30b of the battery case 30, while the other is disposed on the side of the upper wall 30u of the battery case 30. In other words, the round roll portions 20r of the electrode body 20 are disposed one above the other in a vertical direction Z. The pair of end portions of the electrode body 20 in the width direction Y is disposed so as to face the pair of short-side walls 30n of the battery case 30. The pair of flat roll portions 20f of the electrode body 20 is disposed so as to face the pair of long-side walls 30w of the battery case 30. In other words, the pair of flat roll portions 20f of the electrode body 20 is disposed along the array direction X.

While the electrode body 20 is a rolled electrode body in the shown example, the form of the electrode body 20 is not limited to this example. The electrode body 20 may be a laminated electrode body in which a plurality of sheet-shaped positive electrodes and a plurality of sheet-shaped negative electrodes are alternately laminated.

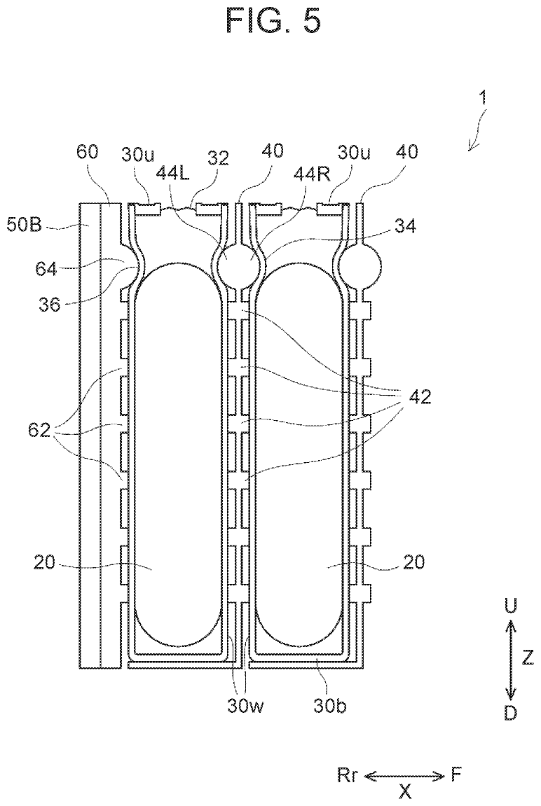

FIG. 5 is a schematic partial sectional view of a rear part of the battery pack 1 taken along a stacking direction and an up-down direction. The spacer 40 is interposed between two adjacent single cells 10. The spacer 40 is made of, for example, a resin material, such as polypropylene (PP) or polyphenylene sulfide (PPS), or a metal material having high heat conductivity.

In the shown example, the spacer 40 has a plurality of ribs 42 on each surface. A form of the spacer 40 not having the ribs 42 is also possible. The ribs 42 may have the same configuration as the ribs of a spacer of a commonly known battery pack. In the shown example, the ribs 42 face the electrode body 20 (particularly the flat roll portion 200. Since a binding load is applied to the battery pack 1, the ribs 42 press the battery case 30 with the binding load. As the battery case 30 is pressed, expansion, etc. of the electrode body 20 can be restricted.

In the shown example, the ribs 42 are arranged in a comb-like row to allow a cooling fluid (e.g., air) to pass through a gap between the spacer 40 and the battery case 30. Having such ribs 42, the spacer 40 functions as a heat dissipating member that dissipates heat generated inside the single cell 10. The arrangement of the ribs 42 is not limited to this example.

The spacer 40 has, on a surface facing the right single cell 10, a convex portion 44R that protrudes toward the single cell 10. The spacer 40 further has, on a surface facing the left single cell 10, a convex portion 44L that protrudes toward the single cell 10.

In the following, the spacer 40 and the single cell 10 on the right side thereof will be specifically described. The convex portion 44R is in contact with the battery case 30 of the single cell 10. A contact portion 34 of the battery case 30 that is a portion in contact with the convex portion 44R protrudes into the battery case 30. The contact portion 34 serves as a stopper when the electrode body 20 moves in a direction toward the contact portion 34 (i.e., in the upward direction U in FIG. 5). Thus, the contact portion 34 protrudes into the battery case 30 so as to be able to stop the electrode body 20 from moving in the direction toward the contact portion 34.

In the shown example, the contact portion 34 protrudes into the battery case 30 as the long-side wall 30w deforms under the binding load into a shape corresponding to the convex portion 44R of the spacer 40. The contact portion 34 is concave when seen from an outer surface side of the single cell 10 and convex when seen from an inner surface side of the single cell 10. Since the contact portion 34 can be protruded into the battery case 30 by deforming the battery case 30 by the binding load, the long-side wall 30w of the battery case 30 of the single cell 10 before assembly of the battery pack 1 may be flat. Alternatively, to make it easy to position the convex portion 44R of the spacer 40 and the battery case 30, a portion of the long-side wall 30w of the battery case 30 that is to come into contact with the convex portion 44R of the spacer 40 may be deformed before assembly of the battery pack 1 so as to become concave when seen from the outer surface side of the single cell 10. In this case, that portion of the long-side wall 30w may be deformed into a shape corresponding to the convex portion 44R of the spacer 40, but it is preferable that the amount of deformation be smaller than that so as not to hinder insertion of the electrode body 20 into the battery case 30.

The contact portion 34 has a protrusion protruding into the battery case 30. The dimension of this protrusion can be determined as appropriate according to the design of the single cell 10 and the electrode body 20. The dimension of the protrusion in the protruding direction (i.e., the height of the protrusion; specifically, the dimension from an inner surface of the battery case 30 to the apex of the protrusion in the array direction X) is preferably not smaller than 0.5% nor larger than 15%, and more preferably not smaller than 2% nor larger than 10%, of the thickness of the electrode body 20.

In the shown example, the contact portion 34 is located so as to face an end portion of the electrode body 20. In this case, the electrode body 20 can be effectively stopped from moving, so that damage due to external impact is less likely to occur. However, the position of the contact portion 34 is not limited to this example and can be set as appropriate according to the outer shape of the electrode body 20. For example, when the electrode body 20 has an outer shape with a depression at a central part, the contact portion 34 may be provided at a position in the battery case 30 facing the depression at the central part of the electrode body 20.

It is advantageous that, as in the shown example, the contact portion 34 faces that end portion of the electrode body 20 that is on the side of the electrode terminals (i.e., the positive-electrode terminal 12T and the negative-electrode terminal 14T). Internal disconnection of the terminals is more likely to occur when the electrode body 20 moves in a direction toward the electrode terminals. This configuration can restrict movement of the electrode body 20 in the direction toward the electrode terminals, so that damage due to external impact is less likely to occur. In the shown example, the positive-electrode terminal 12T and the negative-electrode terminal 14T are mounted on the lid, and the lid and the case main body are welded together. This configuration can reduce the likelihood of fatigue deterioration of the weld between the lid and the case main body.

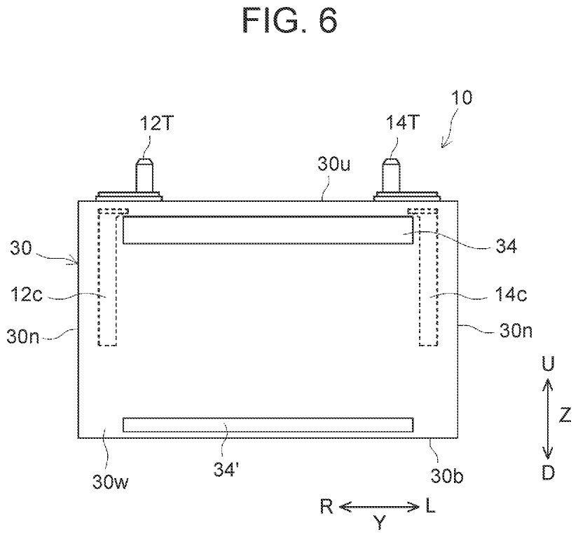

FIG. 6 schematically shows a more preferred form of the single cell. In the more preferred form, the spacer 40 further has, on at least one of the surfaces facing the single cells 10, a second convex portion that protrudes toward the single cell 10, and a contact portion (second contact portion) 34′ of the battery case 30 that is a portion in contact with the second convex portion protrudes into the battery case 30 so as to be able to stop the electrode body 20 from moving in a direction toward the second contact portion 34′, and the second contact portion 34′ is located so as to face an end portion of the electrode body 20 on the opposite side from the electrode terminals. Thus, when the first contact portion 34 and the second contact portion 34′ are respectively provided at both end portions of the electrode body 20 as shown in FIG. 6, movement of the electrode body 20 can be further restricted, so that damage due to external impact is even less likely to occur.

In the shown example, the contact portion 34 protruding into the battery case 30 is in contact with the electrode body 20. However, the contact portion 34 need not be in contact with the electrode body 20. The smaller the distance between the contact portion 34 and the electrode body 20 is, the further the movement of the electrode body 20 can be restricted. In particular, it is advantageous that the contact portion 34 is in contact with the electrode body 20. The contact portion 34 may be directly in contact with the electrode body 20, or when the electrode body 20 is covered with an insulation film, the contact portion 34 may be indirectly in contact with the electrode body 20 through the insulation film.

The spacer 40 has, also on a surface facing the left single cell 10, a convex portion 44L that protrudes toward the single cell 10. The configuration of the surface of the spacer 40 facing the left single cell 10 and the left single cell 10 is the same as that described above. Specifically, the convex portion 44L is in contact with the battery case of the left single cell 10, and similarly, a contact portion of the battery case that is a portion in contact with the convex portion 44L protrudes into the battery case so as to be able to stop the electrode body from moving in a direction toward the contact portion. However, the spacer 40 may have the convex portion on only one of the surfaces.

It is advantageous that, as in the shown example, the spacer 40 has the convex portions 44R, 44L on the respective surfaces, and that the contact portions of the battery case 30 of the single cell 10 sandwiched between the spacers 40 that are portions in contact with these convex portions protrude into the battery case 30 of the single cell 10 and keep the electrode body 20 in place by holding the electrode body 20 from both sides. This configuration can firmly fix the electrode body 20 and thereby further restrict the movement of the electrode body 20, so that damage due to external impact is even less likely to occur. In particular, it is more advantageous when the electrode body 20 is a rolled electrode body as in the shown example, because then the round roll portions 20r are provided at the end portions of the electrode body 20, which makes it easy to keep the electrode body 20 in place by holding the end portions thereof from both sides.

A surface of the end spacer 60 facing the end plate 50B is flat. On the other hand, the end spacer 60 has ribs 62 on a surface facing the single cell 10. Like the ribs 42 of the spacer 40, the ribs 62 are arranged in a comb-like row. The end spacer 60 may have the same configuration as a commonly known end spacer disposed between an end plate and a single cell. However, it is advantageous that the end spacer 60 further has a convex portion 64 on the surface facing the single cell 10 as in the shown example. Like the convex portion 44R of the spacer 40, the convex portion 64 is in contact with the battery case 30 of the single cell 10, and a contact portion 36 of the battery case 30 that is a portion in contact with the convex portion 64 protrudes into the battery case 30 so as to stop the electrode body from moving toward the contact portion 36. This configuration makes it less likely that the single cell 10 located at the end of the battery pack 1 may get damaged due to external impact. Alternatively, a configuration of the end spacer 60 not having the convex portion 64 can be adopted.

The battery pack 1 configured as has been described above is less prone to damage due to external impact, such as internal short-circuit or internal disconnection of the terminals. Moreover, the battery pack 1 is less prone to fatigue deterioration of the weld between the lid and the case main body of the battery case. The battery pack 1 can be used for various applications. For example, the battery pack 1 can be suitably used as a power source (driving power source) for a motor mounted in a vehicle. While the type of the vehicle is not particularly limited, the vehicle is typically an automobile, for example, a plug-in hybrid vehicle (PHV), a hybrid vehicle (HV), or an electric vehicle (EV). The battery pack 1 can also be used as an industrial or household electricity storage device.

To demonstrate the effects of the battery pack disclosed herein, the inventors have actually conducted simple tests using a single cell and a pair of spacers. Examples of these tests will be described below, but these test examples do not in any way limit the disclosure.

Production of Test Pieces

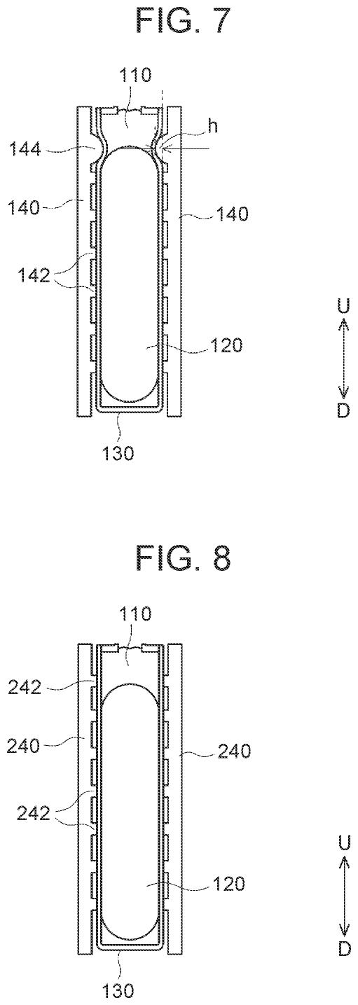

A single cell 110 having a rolled electrode body 120 housed inside a battery case 130 as shown in FIG. 7 was prepared. The configuration of the rolled electrode body 120 of the single cell 110 was the same as that of a common lithium-ion secondary battery. The battery case 130 was composed of a case main body and a lid, which were joined together by laser welding. Terminals (not shown) were mounted to the single cell 110 as in FIG. 2 and FIG. 3.

A pair of spacers 140 having ribs 142 and a convex portion 144 on one surface as shown in FIG. 7 was prepared. The spacers 140 were made of PP. The single cell 110 was sandwiched between the pair of spacers 140 such that the surfaces having the convex portion 144 and the ribs 142 face the single cell 110. This set was further sandwiched between a pair of stainless-steel binding plates and a binding load was applied. The area of contact between the binding plate and the spacer 140 was 13 cm², and the load applied was 50 N. Thus, a test piece for Test Example 1 was produced. In the test piece for Test Example 1, contact portions of the battery case 130 that were portions in contact with the convex portions were deformed by the binding load and protruded into the battery case 130, and a dimension h of the protrusion in the protruding direction (h in FIG. 7) was 0.2 cm.

For Test Example 2, a test piece was prepared in which the dimension of the convex portion 144 was changed and the dimension h (in FIG. 7) of the contact portion in the protruding direction was 0.4 cm.

A pair of spacers 240 having ribs 242 and no convex portion as shown in FIG. 8 was prepared. The spacers 240 were also made of PP. Each spacer 240 had the ribs 242 also at a part corresponding to the part of the spacer 140 where the convex portion 144 was provided. The single cell 110 was sandwiched between the pair of spacers 240 such that the surfaces having the ribs 242 face the single cell 110. This set was further sandwiched between a pair of stainless-steel binding plates and a binding load was applied. The area of contact between the binding plate and the spacer 240 was 13 cm², and the load applied was 50 N. Thus, a test piece for Test Example 3 was produced. In the test specimen for Test Example 3, the dimension h (in FIG. 7) in the protrusion direction was equivalent to 0 cm.

Impact Resistance Test

The test pieces for Test Examples 1 to 3 were subjected to impact directed upward (in the U-direction in the drawings). The test pieces having been subjected to the impact were observed by X-ray transmission and checked as to whether movement of the electrode body 120 and internal disconnection occurred. In the impact resistance test, the strength of the impact was varied from 10 G to 100 G. The result is shown in Table 1. [Table 1]

TABLE 1

| | | Test Example 1 | Test Example 2 | Test Example 3 |
|---|---|---|---|---|
| Dimension h (cm) | | 0.2 | 0.4 | 0 |
| Strength | 10 G | ◯ | ◯ | ◯ |
| of impact | 20 G | ◯ | ◯ | ◯ |
| | 30 G | ◯ | ◯ | ◯ |
| | 40 G | ◯ | ◯ | X |
| | 50 G | ◯ | ◯ | X |
| | 70 G | X | ◯ | X |
| | 100 G | X | ◯ | XX |

◯: Neither movement of the electrode body nor internal disconnection occurred.
X: Movement of the electrode body occurred but internal disconnection did not.
XX: Both movement of the electrode body and internal disconnection occurred.

The result in Table 1 shows that providing the convex portions on the spacers and protruding the contact portions of the battery case in contact with the convex portions into the battery case can reduce the likelihood of movement of the electrode body and internal disconnection.

Test on Resistance of Weld of Battery Case to Fatigue Deterioration

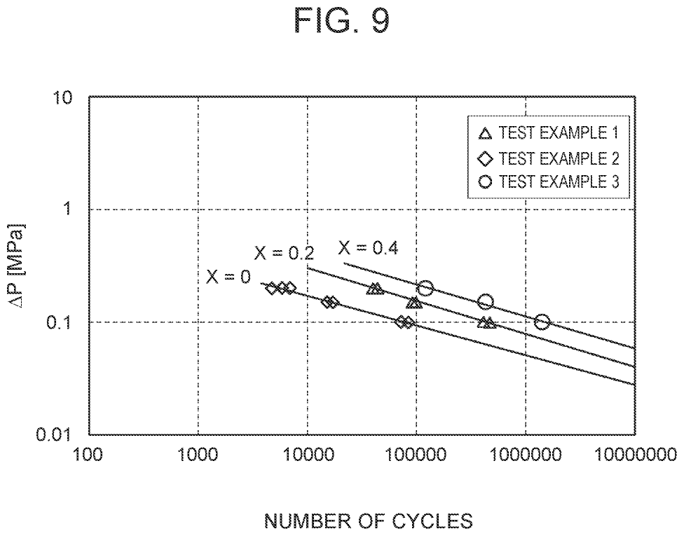

The internal pressure of each single cell of the test pieces for Test Examples 1 to 3 was changed by introducing air into the cell through a side surface portion thereof. The initial internal pressure of the cell was 0.25 MPa, and a change in the internal pressure of ±0.20 MPa was counted as one cycle. The internal pressure was repeatedly changed, and the number of cycles at which air leaked through the weld between the lid and the main body of the battery case 130 was obtained. Further, the number of cycles at which air leaked through the weld, with a change in the internal pressure of ±0.15 MPa counted as one cycle, and the number of cycles at which air leaked through the weld, with a change in the internal pressure of ±0.10 MPa counted as one cycle, were also obtained. The result is shown in FIG. 9.

The result in FIG. 9 shows that providing the convex portions on the spacers and protruding the contact portions of the battery case in contact with the convex portions into the battery case can reduce the likelihood of fatigue deterioration of the weld between the lid and the main body of the battery case.

While specific examples of the disclosure have been described in detail above, these examples are merely illustrative and do not limit the scope of the claims. The technique described in the claims include various modifications and changes made to the specific examples illustrated above.

What is claimed is:

1. A battery pack comprising:
a plurality of single cells each having an electrode body and a battery case housing the electrode body, and arrayed in a predetermined direction; and
one or more spacers each disposed between two of the single cells that are adjacent to each other in the predetermined direction, wherein:
the spacer has, on at least one of surfaces facing the single cells, a convex portion that protrudes toward the single cell;
the convex portion is in contact with the battery case of the single cell; and
a contact portion of the battery case that is a portion in contact with the convex portion protrudes into the battery case so as to be able to stop the electrode body from moving in a direction toward the contact portion.

2. The battery pack according to claim 1, wherein the contact portion is located so as to face an end portion of the electrode body.

3. The battery pack according to claim 2, wherein an electrode terminal is mounted on the battery case, and the contact portion is located so as to face an end portion of the electrode body on a side of the electrode terminal.

4. The battery pack according to claim 3, wherein:
the spacer further has, on at least one of the surfaces facing the single cells, a second convex portion that protrudes toward the single cell;
a contact portion of the battery case that is a portion in contact with the second convex portion protrudes into the battery case so as to be able to stop the electrode body from moving in a direction toward the contact portion in contact with the second convex portion; and
the contact portion in contact with the second convex portion is located so as to face an end portion of the electrode body on the opposite side from the electrode terminal.

5. The battery pack according to claim 1, wherein:
each of the spacers has a convex portion on each surface; and
contact portions of the battery case of the single cell sandwiched between the spacers that are portions in contact with the convex portions protrude into the battery case and keep the electrode body in place by holding the electrode body from both sides.
